(19) United States
(12) Patent Application Publication
(10) Pub. No.: US 2009/0060161 A1
(43) Pub. Date: Mar. 5, 2009

(54) METHOD AND SYSTEM TO AUTOMATICALLY BLOCK A TELEPHONE NUMBER

(75) Inventors: John K. Mertz, Los Gatos, CA (US); M. Brendan Philbin, Morgan Hill, CA (US); Ken Dawson, Pleasanton, CA (US)

Correspondence Address: SCHWEGMAN, LUNDBERG & WOESSNER, P.A., P.O. BOX 2938, MINNEAPOLIS, MN, 55402, US

(73) Assignee: Inmate Calling Solutions LLC d/b/a ICSolutions, San Jose, CA (US)

(21) Appl. No.: 12/199,570

(22) Filed: Aug. 27, 2008

Related U.S. Application Data
(60) Provisional application No. 60/968,640, filed on Aug. 29, 2007.

(51) Int. Cl. H04M 3/42

(52) U.S. Cl. 379/210.02

(57) ABSTRACT

A system to automatically block a telephone number is provided. The system, in one example embodiment, comprises a detecting module to detect a refused telephone call; a counter to be adjusted (e.g., incremented) in response to the refused telephone call; a processing module to determine a value of the counter; and a blocking module to block the telephone number based on the value of the counter. The counter is incremented in response to each refused telephone call.

### RELATED APPLICATION

This application claims the priority benefit of U.S. Provisional Application Ser. No. 60/968,640 filed Aug. 29, 2007, the content of which is incorporated herein by reference in its entirety.

### TECHNICAL FIELD

This application relates to a method and system to automatically block a telephone number.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

An inmate of a correctional facility may be allowed to make a telephone call to his/her friends and family. In some situations, call recipients are not willing to talk to the inmate and may refuse the call by hanging up the telephone. The inmate may persist in his/her attempts to establish a communication and keep placing calls to the same number multiple times thereby unnecessarily disturbing the call recipient. The call recipient of the unwanted telephone calls originating at the correctional facility may want to prevent such telephone calls from reaching their telephone number by having their number blocked.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing a network environment within which a method and system to automatically block a telephone call may be implemented, in accordance with an example embodiment;

FIG. 2 is a block diagram illustrating a system to automatically block a telephone call, in accordance with an example embodiment;

FIG. 3 is a flow chart illustrating a method to automatically block a telephone call, in accordance with an example embodiment;

FIGS. 4 and 5 are flow charts illustrating additional operations in a method to automatically block a telephone call, in accordance with an example embodiment;

FIG. 6 is a block diagram illustrating a database table to store a plurality of called device records, in accordance with an example embodiment;

FIG. 7 is a block diagram illustrating a called device record, in accordance with an example embodiment;

FIG. 8 is a block diagram illustrating a restriction table record, in accordance with an example embodiment; and

FIG. 9 illustrates a diagrammatic representation of a machine in the example form of a computer system within which a set of instructions, for causing the machine to perform any one or more of the methodologies discussed herein, may be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B.” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In an example embodiment, a method and a system are provided to automatically block a telephone number from being reached by a calling party using a calling device. Even though there may be no specific limitations on the destinations of the telephone calls made from correctional facilities, some inmates may make repeated calls to the same telephone number even though the called party is not willing to speak to the inmate thus creating an inconvenience to the called party. The method and process to automatically block a telephone number may alleviate the problem of receiving repeated undesired telephone calls by blocking the calling party from reaching the called device. Accordingly, all inmates at a particular facility or a specific inmate (as applicable, the “Calling Party”) may be blocked from reaching the called device associated with a telephone number after a certain number of calls to that telephone number have been refused.

A refused telephone call may include a telephone call that is answered but where the called party does not affirmatively accept the call either by pressing a designated telephone key or saying an acceptance word. In one example embodiment, in order to track the number of refused calls to a particular telephone number, every time a telephone call to that telephone number from the Calling Party is refused, a counter is incremented. When the counter reaches a certain threshold, the telephone number is automatically blocked from being reached by the Calling Party. In some example embodiments, a Calling Party attempting to make a telephone call to the blocked telephone number may hear an engaged tone. In some example embodiments, a Calling Party attempting to make a telephone call to the blocked telephone number may hear an announcement informing the person that the called telephone number is blocked from being reached from the calling device or by the Calling Party. The called device associated with the blocked telephone number may no longer ring. Whenever the value of the counter approaches the threshold, the called party may be informed that another refusal of the call will result in their telephone number being blocked from receiving further calls from the calling device or Calling Party. The user may be permitted to indicate that they wish to allow further calls to their telephone number from the calling device or Calling Party by pressing a designated telephone key.

In some situations, a telephone call may terminate after a predetermined (e.g., 10 seconds) period of time due to the call being picked up by an answering machine. Such termination of a telephone call may be referred to as an automated refusal of a telephone call. In one example embodiment, the method to automatically block a telephone number may differentiate between an automated refusal and a manual refusal. Accordingly, in one example embodiment, an automated refusal of a telephone call may not result in the counter being incremented whereas a manual refusal would result in the counter being incremented.

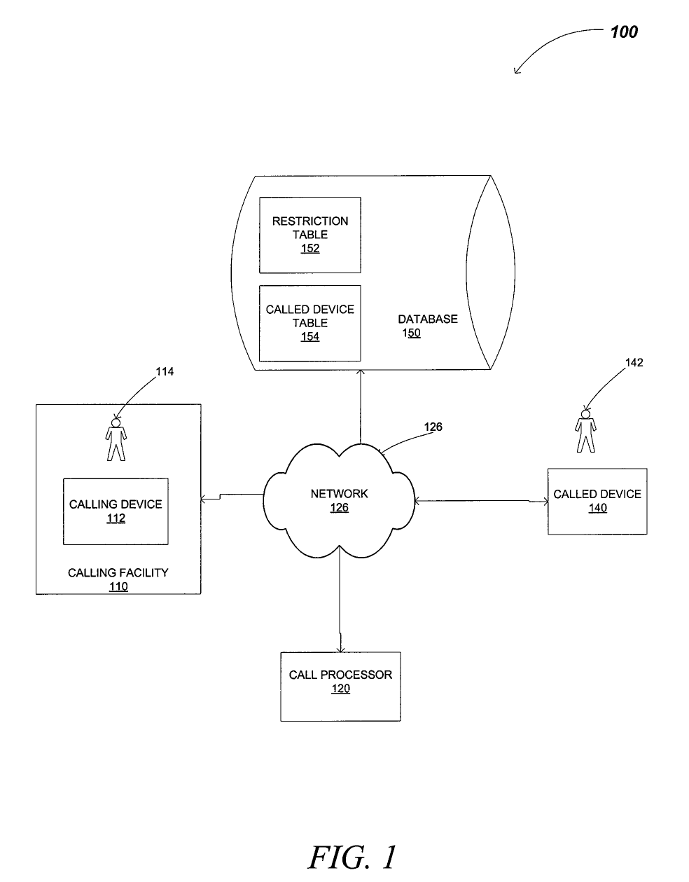

FIG. 1 shows a network environment 100, within which a method and system to block a telephone number may be implemented, in accordance with an example embodiment. As shown in FIG. 1, a calling device 112 residing at a calling facility 110 may be utilized by a calling party 114 to call a called device 140, via a network 126, within the context of the network environment 100. A call processor 120 may be configured to monitor communications between the calling device 112 and the called device 140, collect and record statistics associated with the communications between the calling device 112 and the called device 140, including statistics applicable to a Calling Party, as well as to perform functions to control communications between a Calling Party 114 or the calling device 112 and the called device 140. In some example embodiments, the call processor 120 may be located outside of the calling facility 110, and, in some example embodiments, may include conventional telecommunication components. As an example, the calling facility 110 may be a correctional facility. The network environment 110 may be any communications environment facilitating Voice over Internet Protocol (VoIP) communications, a cellular communications network, Plain Old Telephone Service (POTS), or the like.

The network environment 100 may further include a database 150. The database 150, in one example embodiment, comprises a restriction table 152 and a called device table 154. The restriction table 152 contains records of restricted telephone numbers. Some of the restricted telephone numbers may include victims, potential witnesses, jury, and judges. The called device record 154 contains refused telephone call data as described in more detail below. The database 150 may be accessible by the call processor 120 via the network 126. It will be noted, that in some example embodiments, the database 150 and the call processor 120 may be hosted by the same computer system.

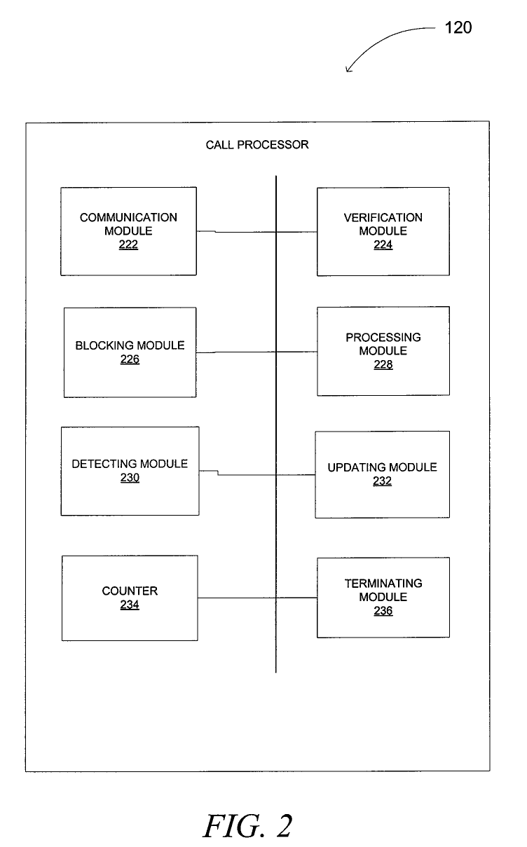

The restriction table 152 and the called device table 154 may be queried by a verification module 224 of the call processor 120, as described in more detail below, to determine whether the telephone call between the Calling Party 114 or the calling device 112 and the called device 140 is allowed. As mentioned above, the calling facility 110 may be located within a correctional facility (e.g., a prison). One or more calling devices 112 may be utilized by inmates of the correctional facility to place telephone calls to a telephone number associated with the called device 140 outside of the facility. An inmate may have an assigned unique identification number (e.g., a personal access number) to be used with every call made within the calling facility or within a larger system (e.g., all U.S. prisons) to the one or more called devices 140. For the purpose of illustration only, some elements of the network environment 100 are described below with reference to a correctional facility environment where the calling devices 112 may be utilized by inmates to make telephone calls from the calling facility 110 located within such correctional facility to various called devices 140. It will be noted, that the use of the calling device 112 is not limited to any particular group of users or facilities and an example system to automatically block telephone calls can be configured for use at facilities other than correctional facilities. A system to automatically block a telephone number is described by way of example with reference to FIG. 2.

Referring to FIG. 2 of the drawings, the example call processor 120 is shown to include several components that may be configured to perform various operations facilitating processing a request for communication between a calling device and a called device (e.g., see FIG. 1). In some example embodiments, the call processor 120 may include a communication module 222, a verification module 224, a blocking module 226, a processing module 228, a detecting module 230, an updating module 232, a counter 234, and a call terminating module 236.

The communication module 222 may be configured to receive a request from the calling device 112 to establish a call to the called device 140. The detecting module 230 may be configured to detect a telephone call refused by a person associated with the called device 140. As explained in more detail below, such detection may also be used to establish whether the telephone call, refused by the called device 140, was not refused automatically (e.g., via an answering machine). The blocking module 226 may be configured to block the establishing of the call between the calling device 112 and the called device 140. The updating module 232 may be configured to update the counter 234 in response to the called party 142 refusing a call (e.g., answering a telephone call and shortly thereafter terminating the telephone call when the called party 142 identifies the caller) from the calling party 114 or the calling device 112.

The detecting module 230 may be configured to monitor the telephone keys pressed or a key word spoken by the called party 142 via the called device 140 as explained in more detail below. In the event the called party 142 neglects to press the designated telephone key or say the expected key word, then the telephone call may be considered refused and the counter 234 incremented. The detecting module 230 may be configured to differentiate between a manual and an automated refusal of the telephone call (e.g., via an answering machine).

The verification module 224 may be configured to verify that the calling party 114 or calling device 112 is not blocked from establishing the telephone call between the calling device 112 and the called device 140. As an example, the calling party 114 may call a number associated with the called device 140 that has been blocked from being reached by the calling party 114 through calling device 112. As a result, the telephone call will not be established and the calling party 114 may get an announcement made via the calling device informing the calling party 114 that the called device 140 has been blocked due to refused calls exceeding the threshold.

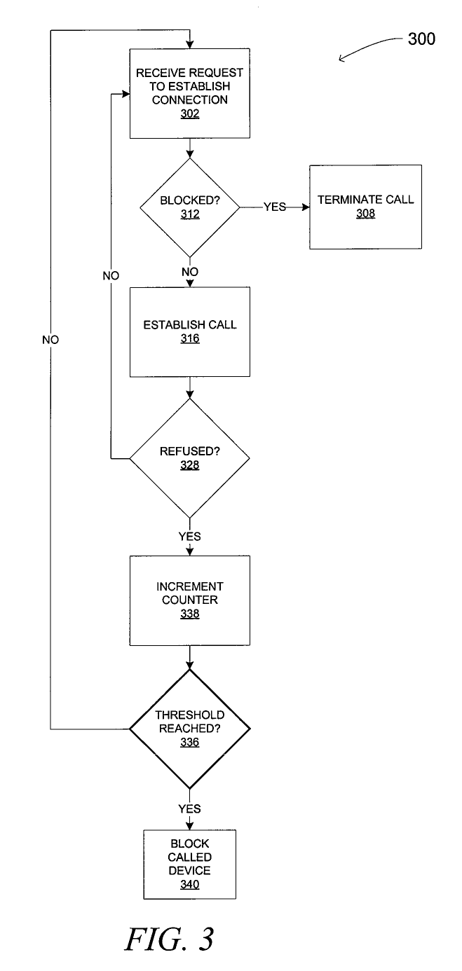

As described above, if the called party 142 associated with the called device 140 refuses calls placed by the calling party 114 through the calling device 112 more than a predetermined number of times, the called device 140 will be blocked from receiving calls from the calling party 114. Accordingly, the processing module 228 may be configured to determine that the value of the counter 234 (e.g., 6 calls) corresponds to the threshold as explained in more detail below. The counter 234 may be configured to increment its value when the call between the calling party 114 acting through any calling device 112 and the called device 140 is refused by the called device 140. The terminating module 236 may be configured to terminate a call when the calling party 114 acting through the calling device 112 is restricted from establishing the telephone call to the called device 140. The operations performed by the call processor 120 are described by way of example with reference to FIG. 3.

FIG. 3 illustrates an example flow diagram of a method 300 to automatically block a telephone number. The method 300 may begin with the call processor 120 receiving a request to establish a connection to a called device. According to an example embodiment, a person making the telephone call may be an inmate in a correctional facility calling a member of his family. The call processor 120 may investigate the database 150 to determine the identity of the calling party 114 and that the called telephone number was not previously blocked. If the telephone number was previously blocked the connection may be terminated. Otherwise, the connection with the called device 140 may be established.

Once the connection is established, the duration of the connection from the time the telephone call is answered by the called party 142 until the time the telephone call is terminated as well as the actions of the called party 142 are monitored. The telephone call will be monitored for a refused call by detecting a hang-up condition and the lack of an acceptance key being pressed or acceptance word spoken by the called party 142 via the called device 140. Whether the telephone call is considered refused may depend upon the call duration. For example, if the telephone call persists for a duration in excess of a predetermined time (e.g. 10 seconds), the telephone call is considered to have been answered by an answering machine and not expressly refused by the called party 142. However, when the telephone call is terminated after a short time (e.g., less than 10 seconds) a refused telephone call is detected, and a counter 234 may be incremented. In one example embodiment, the telephone number associated with the called device 140 will be blocked from being reached by the calling party 114 via any calling device 112 once a preset value of the counter 234 is reached. In some example embodiments, the counter 234 may be reset to the original value if the telephone call is not refused.

The method 300 may be performed by processing logic that may comprise hardware (e.g., dedicated logic, programmable logic, microcode, etc.), software (such as run on a general purpose computer system or a dedicated machine), or a combination of both. In an example embodiment, processing logic may reside at a computer system that hosts the call processor 120 of FIG. 2.

The method 300 may be deployed in the example network environment 100 and, accordingly, is described by way of example with reference thereto. As shown at operation 102, a request to establish a telephone call between the calling party 114 through calling device 112 and the called device 140 is received by the communication module 222 of the call processor 120. Thereafter, the verification module 224 of the call processor 120 may query the database 150 to verify that the called device 140 is not blocked from receiving telephone calls from the calling party 114 through a calling device 112. In response to the query, a determination is made at operation 312 as to whether the telephone call may be allowed to reach the called device 140. If it is determined by the verification module 224, at operation 312, that the telephone call is not to be allowed, the call may be terminated at operation 380 by the blocking module 226.

If, however, at operation 312, it is determined by the verification module 224 that the telephone call is not blocked, the telephone call between the calling device 112 and the called device 140 is established at operation 316. At operation 328, the detecting module 230 may detect that the telephone call was refused by the called device 140. The criteria that may be used to ascertain that the telephone call is a refused telephone call are explained in more detail below. If, at operation 328, the detecting module 230 detects that the telephone call was refused, the counter 234 may be incremented at operation 338. If, however, at operation 328, the detecting module 230 does not detect that the telephone call was refused no further actions may need to be taken.

As mentioned above, FIG. 3 is a general schematic flow diagram of an example method for processing a request for a telephone call between a calling party 114 using the calling device 112 and the called party 142 using the called device 140. Some example embodiments of the method to automatically block a telephone number may include additional operations. A method including some example additional operations is described below.

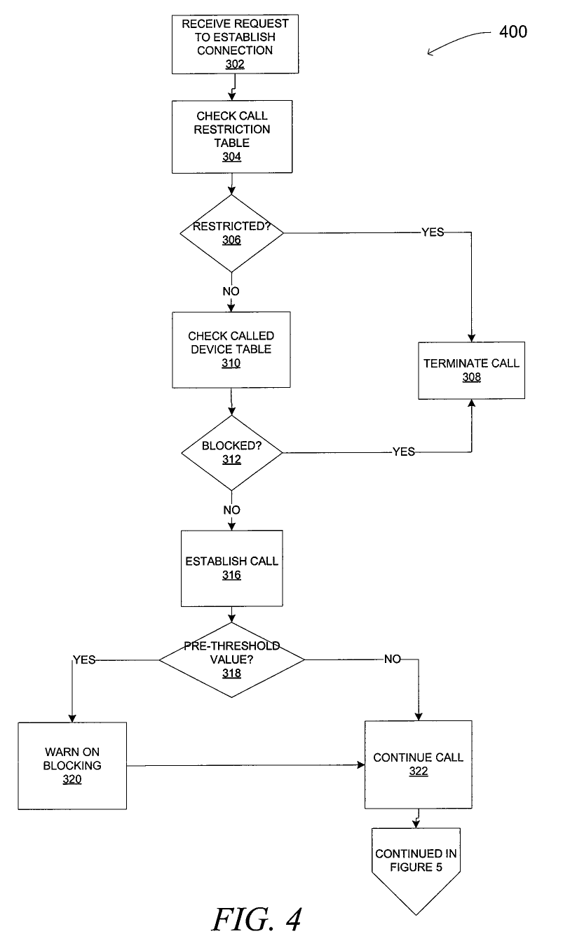

Referring to FIGS. 4 and 5 of the drawings, reference numeral 400 illustrates an example embodiment with additional operations in the method to automatically block a telephone call between the calling device 112 and the called device 140. According to one example embodiment, a request to establish a telephone call between the calling party 114 using the calling device 112 and the called party 142 using the called device 140 is received at operation 302 by the communication module 222 of the call processor 120. Accordingly, at operation 304 the verification module 224 of the calling processor 120 may query the call restriction table 152 of the database 150 to determine whether the calling party 114 or the calling device 112 are restricted from making the telephone call to the called device 140 (e.g. recipients are victims or witnesses). If it is determined at operation 306 that the calling party 114 or calling device 112 are restricted from making the telephone call to the called device 140, the telephone call is terminated at operation 308.

If, however it is determined at operation 306 that the calling party 114 and calling device 112 are not restricted from making telephone calls to the called device 140, the workflow proceeds to query the called device table 154 of the database 150 to determine whether the called device 140 is blocked from receiving telephone calls from the calling party 114 or calling device 112, as shown at operation 310. As explained in more detail below, the called device 140 may be blocked if the number of calls refused at operation 328 exceeded a predetermined threshold of the counter 234.

If it is determined at operation 310 that the called device 140 is blocked from receiving telephone calls from the calling party 114 or the called device 112, the telephone call is not established. If however, it is determined at operation 310 that the called device 140 is not blocked from receiving telephone calls from the calling party 114 and the called device 112, the telephone call may be established by the communication module 222 of the call processor 120, as shown in operation 316.

When the telephone call requested by the calling party 114 through the calling device 112 in operation 302 is established, as in operation 316, the counter 234 may be queried by the verification 224 module of the call processor 120 to determine its current value. Thereafter, at operation 336, the value of the counter 234 may be compared to the pre-determined threshold value by the processing module 224 of the call processor 120. The call processor 120 may be configured to permit a user (e.g., a system administrator) to modify the threshold value. In some example embodiments, the threshold value may be based on the number of refused telephone calls and meeting the threshold value may result in the called device 140 having a permanent block.

At operation 318, it may be determined that the value of the counter 234 is at a predetermined pre-threshold value. The pre-threshold value may be an indication that the calling party 114 or the calling device 112 will be blocked from calling the called device 140 if the telephone call is refused one more time, as shown at operation 320. If, at operation 318, it is determined that the value of the counter 234 is not at the pre-threshold value, the telephone call is allowed to continue without interruptions, as shown at operation 322.

If, however, it is determined, at operation 318, that the value of the counter 234 is at the pre-threshold value, in some example embodiments, a warning announcement may be made, at operation 320, via the called device 140 to the called party 142 associated with the called device 140. The announcement may inform the called party 142 that the threshold number of allowed refused calls will be reached if the telephone call is refused again. A sample announcement may be provided as follows. “You previously refused 5 calls coming from this caller. If you reject this call coming from this caller, the caller will be permanently blocked from making further calls to you. Please press pound sign to indicate that you do not want the caller to be blocked or accept this call by pressing 1.” Alternatively, the announcement may be provided as follows. “You previously refused calls from this facility 5 times. If you refuse this call, your phone number will be permanently blocked for calls from this facility. Please press pound sign to indicate that you do not want calls blocked from this facility or accept this call by pressing 1.”

After the warning announcement is made, at operation 320, the telephone call established between the calling device 112 and the called device 140 is allowed to continue, as shown at operation 322. The telephone call may be further monitored by the detecting module 230 to determine the duration of the telephone call at operation 326. A refused telephone call, as determined at 328, may be defined as a telephone call that lasts below a pre-determined duration. As discussed above, the relatively short pre-determined length of time of the telephone call duration may indicate that a person associated with the called device 140 does not wish to speak to a person associated with the calling device 112. Accordingly, the purpose of detecting the duration of the telephone call, at operation 326, may be to determine whether the telephone call duration was below the predetermined length of time and therefore was refused at operation 328. If, however, it is determined at operation 328 that the call duration is above the pre-determined length of time, it may be concluded that the telephone call was picked up by an answering machine and, therefore, was not expressly refused. In some example embodiments, if the telephone is not refused at operation 328, the counter 234 may be reset to its original value, as shown at operation 330. The original value of the counter 234 may be any value below the threshold value. In some example embodiments, the original value of the counter 234 may be zero. The counter 234 may also be decremented with each refused telephone call until the threshold value is reached.

In some example embodiments, the method to automatically block a telephone number may differentiate at operation 332 between automatic (e.g. answering machine) and human refusal (e.g. person hangs up the telephone). At operation 332, the detecting module 230 may listen for a click or tone sound and based on hearing such sound determine that the refusal is automatic. If it is determined at operation 332 that the refusal is automatic, the counter 234 may be left at its current value and no further action is taken.

If, however, it is determined at operation 332 that the refusal of the telephone call is not automatic, the counter 234 may be incremented, as shown in operation 338. A value by which the counter 234 is incremented may be any value and, in some example embodiments, may be 1. At operation 336, the counter 234 may be evaluated to determine whether the value of the counter 234 is at or above the pre-determined threshold value. If it is determined, at operation 336, that the value of the counter 234 is not at or above the predetermined threshold value, no further actions may need to be taken.

If, however, it is determined at operation 336 that the value of the counter 234 is at or above the predetermined threshold value, the updating module 232 of the call processor 120 may update the called device table 154 to indicate that the telephone number of the called device 140 is blocked from telephone calls coming from the calling party 114 or calling device 112, as shown at operation 340. Accordingly, next time the calling party 114 or, if applicable, any person associated with the calling device 112 attempts to make a telephone call to the called device 140, the telephone call will be blocked at operation 312.

In some example embodiments, the telephone number of the called device 140 in the called device table 154 may be “unblocked” by resetting the counter 234 to its original value, as shown at operation 330, when the called party 142 contacts the call processor 120 operators and requests that the counter 234 value is reset to its original value in the called device table 154 or that the called device 140 be exempt from any automatic blocking action.

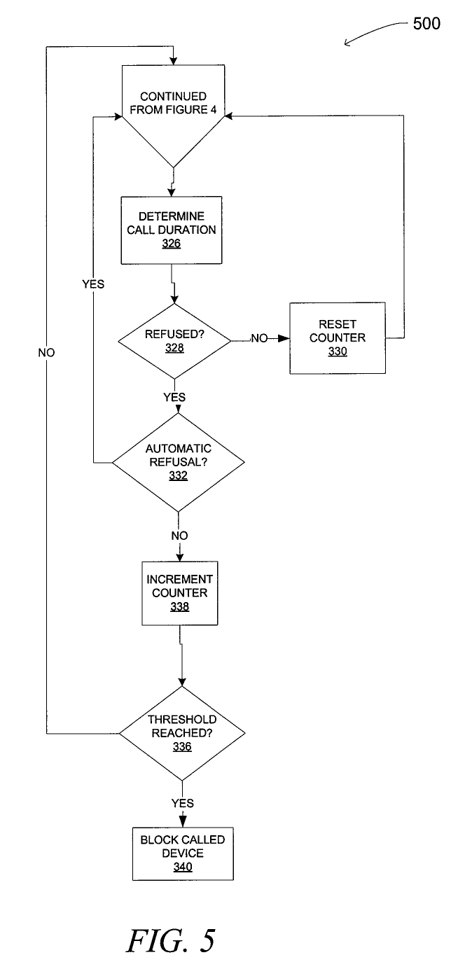

FIG. 6 illustrates the called device table 152 comprising a plurality of called device records 610. A called device record 610 may, in some example embodiments, contain a telephone number column 612, a blocked flag column 612, a blocked PIN column 616, a Do Not Record (DNR) column 618, a Global column 620, and a counter column 622. The telephone number column 612 contains fields that are used to store telephone numbers of the called device which may be a unique identifier of the device record 610. The blocked column 614 contains a flag (e.g., Y) indicating whether the called device 140 is blocked. As explained in more detail above, the called device 140 may be blocked from being reached by the calling party 114 or the calling device 122 if the counter 622 is at or above a predetermined threshold value.

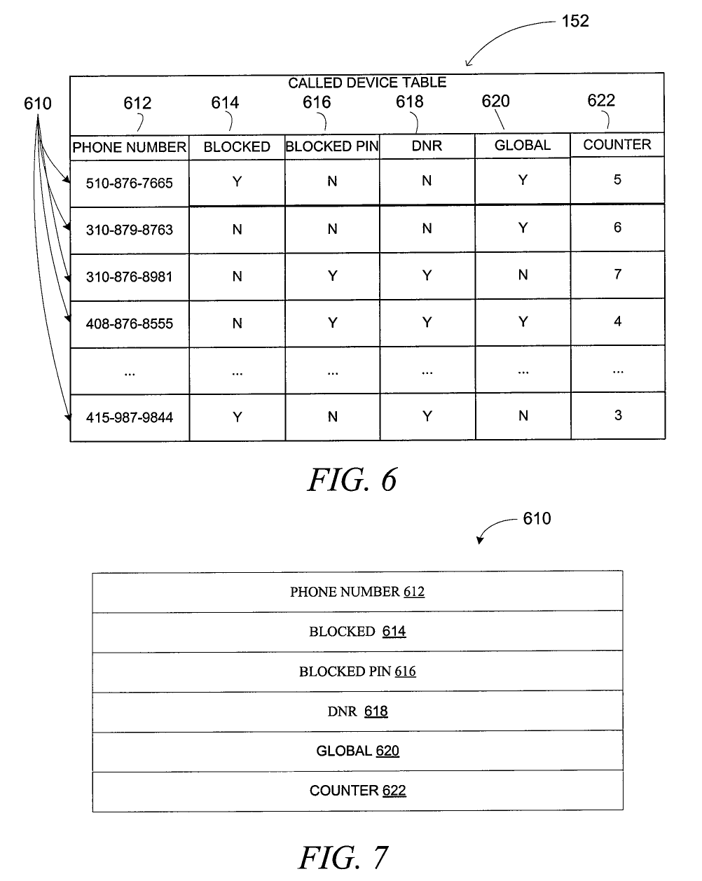

FIG. 7 illustrates a called device record 610. In some example embodiments, calls can be blocked based on the identity of the caller rather than on the called device. Accordingly, the blocked PIN column 616 may contain a flag (e.g., Y) indicating that a person with the Personal Identification Number (PIN) cannot make calls to the called device 140. The global column 620 may contain a flag, positive value of which (e.g., Y) may indicate that the called device 140 is blocked from being reached by any calling device 112 in the calling facility 110. As an example, the global column 620 may be set to “Y” to indicate that the called device 140 is blocked and “N” to indicate that the called device 140 is not blocked. The counter 234 is incremented each time a telephone call to the called device 140 is refused. Accordingly, when the global column 620 is set to Yes, the calling device 112 cannot reach the called device 140. If, however, the global column 620 field has a negative value (e.g., N) it indicates that combined counter value has not reached the threshold. The counter column 622 contains values of the counter with respect to each blocked called device. The counter value may be incremented every time a telephone call is refused. Once the counter reaches its threshold value, the called device is blocked by setting the blocked column value to Yes.

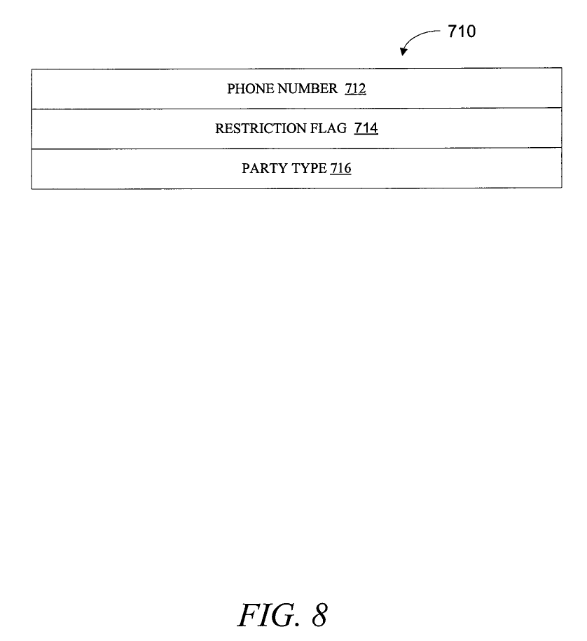

FIG. 8 illustrates a restriction record 710 of the restriction table 154 illustrated in FIG. 1. The restriction record 710 may include, in some example embodiments, a telephone number 712, a restriction flag 714, and a party type 716. In some example embodiments, the restriction record 710 may be generated for each calling party 114 and based on inmates PINs. When the calling party 114 makes a call using the calling device 112 to the called device 140, the restriction table 154 of the restriction database 152 is queried to determine whether the restriction flag 714 is set to a positive value (e.g., Y). Such setting may indicate that the telephone number 712 is restricted from telephone call made by the calling party 114 with the PIN. If the determination is made that the telephone number 712 is associated with the called device 140 is restricted, the telephone call will be terminated. The party type 716 may contain more information on the telephone number 712 associated with the called device 140 such as a user type associated with the called device 140. The party type 716 may contain a value which may be informative as to why the telephone number 712 may be restricted. Examples of the party type 716 may include a victim, a judge, or a potential witness. If the restriction flag is 714 is positive, the telephone call may be terminated. If, however, it is determined that the telephone number 712 is not restricted the telephone call will be allowed to be established.

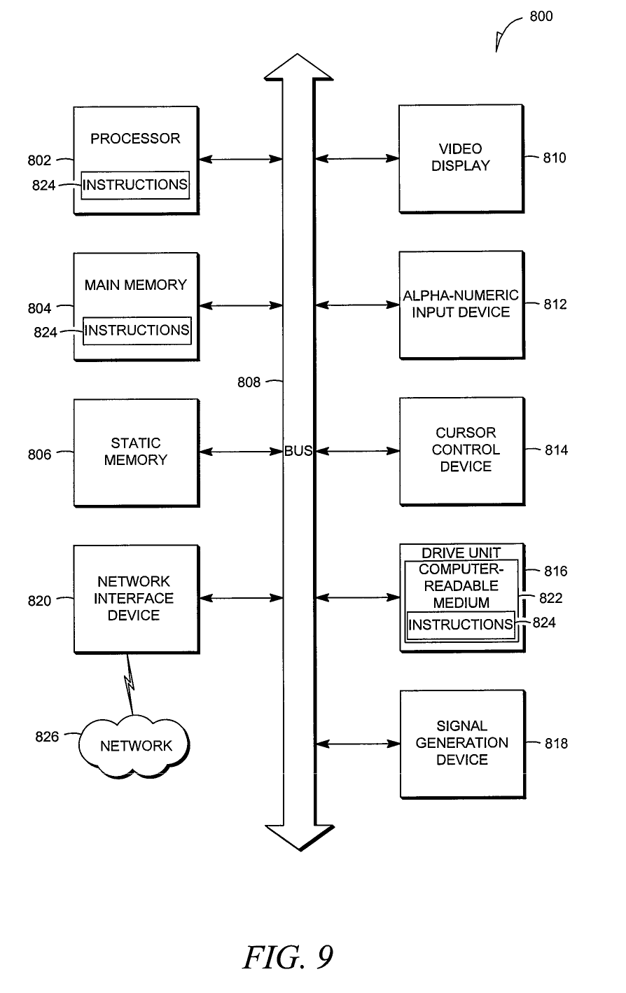

FIG. 9 illustrates a diagrammatic representation of a machine in the example electronic form of a computer system 800 within which a set of instructions, for causing the machine to perform any one or more of the methodologies discussed herein, may be executed. In various example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an MP3 player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 620.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 626 via the network interface device 620 utilizing any one of a number of well-known transfer protocols (e.g., HTTP).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, and optical and magnetic media. Such medium may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, a method and system to automatically block a telephone number have been described. Although example embodiments have been described with reference to specific example embodiments, it will be evident that various modifications and changes may be made to these example embodiments without departing from the broader spirit and scope of the invention. Accordingly, the specification and drawings are to be regarded in an illustrative rather than a restrictive sense.

1. A computer-implemented system, the system comprising:
a detecting module to detect a refused telephone call made to a telephone number, the telephone number associated with a called device;
a counter to be adjusted in response to the refused telephone call; and
a blocking module to automatically block the telephone number associated with the refused telephone call based on a value of the counter.

2. The computer-implemented system of claim 1, further comprising a verification module to verify that the telephone number is permitted to receive a telephone call from a calling party or a calling device.

3. The computer-implemented system of claim 1, further comprising a processing module to determine that the value of the counter corresponds to a predetermined threshold.

4. The computer-implemented system of claim 2, wherein the blocking module is to block the telephone call to the called device when the value of the counter corresponds to the predetermined threshold.

5. The computer-implemented system of claim 3, wherein the blocking module is to unblock the telephone call to the called device in response to a request associated with the called device.

6. The computer-implemented system of claim 1, further comprising a processing module is to determine that the refused telephone call is refused automatically.

7. The computer-implemented system of claim 1, wherein adjusting the counter comprises incrementing the counter and configuring the processing module to reset the value of the counter to zero when the telephone call is accepted.

8. The computer-implemented system of claim 1, wherein the detecting module is to detect acceptance of a telephone call and the duration of the telephone call.

9. The system of claim 1, further comprising a notification module to notify a calling party associated with a called device that the calling party or the calling device are to be blocked from calling the called device if the telephone call is refused.

10. A computer-implemented method, the method comprising:
detecting a refused telephone call to a telephone number;
in response to the detecting, adjusting a counter; and
automatically blocking the telephone number associated with the refused telephone call, based on the value of the counter.

11. The computer-implemented method of claim 10, wherein adjusting of the counter comprises incrementing the counter and blocking of the telephone number comprises determining that the value of the counter is above a threshold.

12. The computer-implemented method of claim 10, further comprising providing to a called party associated with the refused telephone call an option to not block the telephone number.

13. The computer-implemented method of claim 10, wherein adjusting of the counter comprises determining that a receipt of the refused telephone call is not an automated receipt.

14. The computer-implemented method of claim 10, comprising:
detecting an accepted telephone call associated with the telephone number; and
resetting the value of the counter.

15. The computer-implemented method of claim 14, wherein the detecting of the accepted telephone call comprises determining that a predetermined key was pressed or a predetermined keyword was spoken at the called device.

16. The computer-implemented method of claim 10, comprising:
receiving a request associated with the refused telephone number to unblock the telephone number; and
unblocking the telephone number.

17. The computer-implemented method of claim 10, comprising notifying a called party associated with the refused telephone call that the telephone number will be blocked if the threshold is exceeded.

18. The computer-implemented method of claim 10, wherein the telephone number associated with the refused telephone call is blocked based on identification of a calling device or a calling party.

19. A computer-readable medium comprising instructions, which when implemented by one or more processors perform the following operations:
detect a refused telephone call from a calling device or a calling party;
adjust a counter in response to the detecting; and
automatically block the telephone number associated with the refused telephone call based on the value of the counter.

20. A computer-implemented system comprising:
means for detecting a refused telephone call from a calling device or a calling party;
means for adjusting a counter in response to the detecting; and
means for automatically blocking the telephone number associated with the refused telephone call based on the value of the counter.
